(19) United States
(12) Patent Application Publication
(10) Pub. No.: US 2012/0145646 A1
(43) Pub. Date: Jun. 14, 2012

(54) Method for Removal of Iron from an Aqueous Solution

(75) Inventors: Nam-Sook Bae, The Woodlands, TX (US); Jeffrey McKennis, The Woodlands, TX (US)

(73) Assignee: TETRA Technologies, Inc., The Woodlands, TX (US)

(21) Appl. No.: 12/963,386

(22) Filed: Dec. 8, 2010

(51) Int. Cl. C02F 1/64; C02F 1/72; C02F 1/66; C02F 1/52

(52) U.S. Cl. 210/724; 210/702

(57) ABSTRACT

Methods are disclosed for the removal of iron from aqueous solutions. The methods involve facilitating formation of an iron salt precipitate by introducing a source of anions to the solution and adjusting the pH of the solution through the addition of one or more acids, separating the iron salt precipitate from the aqueous solution, and removing residual anions in the aqueous solution.

### FIELD OF THE INVENTION

The invention relates generally to the removal of iron from aqueous solutions, and more particularly, to the removal of iron from the aqueous solutions that are used in connection with oil and gas retrieval and production operations.

### BACKGROUND

Brines are aqueous solutions having one or more salts or mixtures of salts dissolved therein. Brines may be used in a variety of capacities in connection with the servicing of oil and gas wells including, for example, as drilling fluids. The exact composition of the brine determines its physical and chemical properties.

Brines may become contaminated with impurities during use in oil and gas operations. Iron may be a source of brine contamination. An excessive amount of iron in brine may contribute to a variety of undesirable consequences including the damage to the formation, acceleration of the corrosion of metallurgy in the well environment, and impairment of the completion process.

### SUMMARY

One or more embodiments of the invention are directed to methods for removal of iron from an aqueous solution. One or more specific embodiments of the invention are directed to methods for rapid removal of iron from a used brine fluid.

In an embodiment of the invention, a method for removal of iron from an aqueous solution comprises: facilitating formation of an iron salt precipitate; separating the iron salt precipitate from the aqueous solution; and removing residual anions in the aqueous solution. In accordance with one or more embodiments of the invention, the presence of iron in the brine may be a result of contamination during use of the brine in connection with an oil and gas operation.

The aqueous solution may be a brine fluid that has been used in connection with oil and gas operations. More particularly, the aqueous solution may be at least one of: a work-over brine, a completion brine, frac water or frac fluid, and flowback fluids.

The formation of an iron salt precipitate may be facilitated by adjusting the of the brine fluid to lower than about 6.5 by adding a sufficient amount of an acid. Any acid that can adjust the pH of the brine fluid to a value up to 6.5, to thereby induce precipitation of the iron salt, may be used. In one or more embodiments, the acid may be selected from the group consisting of: hydrochloric acid, sulfuric acid, phosphoric acid, phosphonic acid, hydrobromic acid, formic acid and acetic acid.

In one or more embodiments, the formation of the iron salt precipitate is facilitated by the addition of a source of anions. The source of anions may be a sulfate or a phosphate salt. The phosphate salt may be in the tri- di- or mono-basic phosphate form. The source of anions may he introduced along with the acid. In another embodiment, the source of anions may be phosphoric acid or sulfuric acid.

The iron salt precipitate may be removed by settling, filtration and/or centrifugation. The aqueous solution may contain a residual amount of anions. In one or more embodiments, the residual anions comprise phosphate or sulfate ions. The residual phosphate or sulfate ions may be removed by the addition of a sufficient amount of an alkali or alkali earth oxide or hydroxide to the aqueous solution. In one or more embodiments, quick lime (calcium oxide) or calcium hydroxide may he added to the aqueous solution. In another embodiment, sodium or potassium hydroxide may be added to the aqueous solution. Brines free of calcium may require the addition of alkali earth oxide or hydroxide. However, if the residual phosphate content of the fluid does not affect its use and/or if the residual phosphate content is minimal, the phosphate removal step can be omitted.

Removal of the residual phosphate or sulfate ions may involve adjusting the pH of the aqueous solution to about 2.5 or higher. The optimal pH depends on the composition of the brine. The resultant alkali earth phosphate or alkali earth sulfate may be precipitated from the aqueous solution. The residual iron content of the brine after application of the above-described method with or without phosphate or sulfate removal may be within a range of about 100 ppm to about less than 1 ppm.

In another embodiment of the invention, a method for rapid on-site reclamation of used brine that comprises iron and one or more salts is disclosed. The method comprises: facilitating formation of an iron phosphate precipitate by adjusting the pH of the brine to lower than about 6.5 by adding one or more acids along with a source of phosphate ions to the brine; filtering the iron phosphate precipitate from the brine; and removing residual phosphate ions from the brine.

In a more specific embodiment of the method for rapid on-site reclamation of used brine, the formation of the iron phosphate precipitate may be facilitated by adjusting the pH of the brine to within a range of about 2.5 to about 4.5 by adding hydrochloric acid and phosphoric acid to the brine. The phosphate ions may be added in any molar amount of iron present in the brine. In one embodiment of the invention, a phosphate to iron molar ratio of greater than or equal to 1 results in the removal of variable quantities of phosphate. In another more specific embodiment of the invention, the phosphate to iron molar ratio is within a range of about 2 to about 4. In other embodiments of the invention, even higher phosphate to iron molar ratios may be maintained. However, phosphate disposal costs may be correspondingly increased as the phosphate to iron molar ratio is increased.

Removing the residual phosphate ions in the brine may include facilitating formation of a calcium phosphate precipitate by adjusting the pH of the brine to about 2.5 or greater by adding sodium or potassium hydroxide or quick lime or calcium hydroxide to the brine. The calcium phosphate precipitate may then be separated from the brine. The residual iron content of the reclaimed brine after application of the above-described method with or without phosphate removal may be within a range of about 100 ppm to about less than 1 ppm.

The above-described embodiments of the invention may be carried out at any temperature and pressure. In one embodiment, the methods of the invention are carried out at ambient temperatures or pressures.

These and other embodiments of the invention arc described in further detail in the detailed description that follows.

### BRIEF DESCRIPTION OF THE DRAWING

FIG. 1 shows a graph of Fe concentration (in ppm) as a function of a number of hours of operation of an iron removal process performed at different solution pH levels according to embodiments of the invention.

### DETAILED DESCRIPTION OF THE INVENTION

One or more embodiments of the present invention relate to methods for the removal of iron from an aqueous solution. According to one or more embodiments of the invention, the aqueous solution may be a brine solution for an oil and gas operation. Brine solutions arc solutions of soluble salt in water. However, with use or during storage for extended periods, the brine solution may be contaminated. Brine solutions used in connection with oil and gas operations may be contaminated with iron, suspended solids, drilling mud and other chemicals. The one or more embodiments of the invention may be used to remove iron from used brine solution, thereby permitting reclamation and re-use of the brine solution. Examples of brines used in an oil or gas operation include work-over brines, completion brines, frac water, frac fluids, flowback fluids as well as mixtures thereof.

Brines may be expensive and it is, therefore, desirable to reuse or “reclaim” used brines. Reclamation of used brine involves removing any contamination introduced to the brine during rig operations or transportation. Ideally, the reclamation process will convert the used brine to “new” brine condition or to substantially the same condition that the brine was in before use.

In accordance with an embodiment of the invention, a method for removal of iron from an aqueous solution is disclosed.

The aqueous solution may he deposited in a mixing pit, a tote, a tank, or any receptacle suitable for storing and mixing fluids. Formation of an iron salt precipitate is facilitated by adjusting the pH of the aqueous solution to lower than about 6.5 by adding one or more acids to the aqueous solution. A source of anions may be introduced into the aqueous solution together with the one or more acids. Residual anions may be removed by forming an alkali earth anion precipitate. Formation of the alkali earth anion precipitate is facilitated by adjusting the pH of the aqueous solution to about 2.5 or greater by adding an alkali or alkali earth oxide or hydroxide to the aqueous solution, and separating the alkali earth anion precipitate from the aqueous solution. The iron salt precipitate may be separated from the aqueous solution either prior to or along with the separation of the alkali earth anion precipitate. The one or more embodiments of the invention are rapid, efficient and cost-effective, because they enable the separation of the iron salt precipitate along with the alkali earth anion precipitate from the aqueous solution.

The anions introduced to the aqueous solution may be selected from the group consisting of phosphate anions, sulfate anions, and sulfite anions. Any acid, which is capable of adjusting pH to lower than about 6.5 and thereby inducing an iron salt precipitate, may be used. More specifically, the one or more acids added to the aqueous solution to adjust the pH of the solution may be at least one of: phosphoric acid, phosphonic acid, sulfuric acid, hydrochloric acid, hydrobromic acid, formic acid and acetic acid.

In one or more embodiments of the invention, facilitating the formation of the iron salt precipitate may comprise adjusting the pH of the aqueous solution to lower than about 6.5 by adding hydrochloric acid to the aqueous solution and by further adding sulfuric acid, phosphoric acid, or sulfurous acid to the solution. As previously disclosed, the aqueous solution may be a brine fluid that was contaminated with iron during use in an oil and gas operation.

In those embodiments in which hydrochloric acid and phosphoric acid are added to the aqueous solution to adjust the pH of the solution and facilitate the formation of an iron phosphate precipitate, the phosphoric acid may perform a dual function of serving as the source of anions and contributing, along with the hydrochloric acid, to an adjustment of the pH of the solution. Similarly, in those embodiments in which sulfuric acid or sulfurous acid is added to the aqueous solution to facilitate the formation of an iron sulfate precipitate or an iron sulfite precipitate, respectively, the acid may represent the source of the anions and contribute, along with any additional acids added to the solution, to the adjustment of the pH of the solution

In one or more additional embodiments of the invention, the formation of the iron salt precipitate may be facilitated by: (1) introduction of phosphate, sulfate, or sulfite anions to the aqueous solution through the addition of a phosphate salt, a sulfate salt, or a sulfite salt, respectively, and (2) pH adjustment of the aqueous solution through the addition of any acid that can adjust the pH of the aqueous solution to lower than about 6.5 may be used. In one embodiment, the acid may be at least one of: hydrochloric acid, hydrobromic acid, formic acid, and acetic acid. In these embodiments, the salt may serve as the source of the anions while the acids may be added to the solution to adjust the PH of the solution in a controlled manner and thereby facilitate the formation of the iron salt precipitate.

Any acid may be used to adjust the pH of the aqueous solution so long as the acid does not induce precipitation of species other than iron that may be present in the solution. For example, as discussed earlier, hydrochloric, hydrobromic, sulfuric, acetic, formic, phosphoric and phosphonic acids may be employed. In an embodiment of the invention, the pH of the solution is adjusted to about 2.5 through the addition of one or more acids. An advantage of adding sulfuric acid, sulfurous acid, or phosphoric acid to the solution is that these acids serve the dual function of lowering the pH of the solution and providing a source of the sulfate, sulfite, or phosphate anions required to form the iron salt precipitate. To further improve precipitation of the iron salt precipitate, an oxidant, for example hydrogen peroxide, may be introduced prior to or at least partially concomitantly with the addition of the acid(s) excluding a scenario in which formic acid is added to the solution. Even in the absence of any oxidizing agent, the methods disclosed would be effective to remove substantially all ferrous and ferric ions present in the brine.

In any of the previously disclosed embodiments, the phosphate introduced to the aqueous solution may be in a tri-, di-, or mono-basic form which is determined by a number of hydrogen atoms bond to oxygen atoms of the phosphate. Similarly, the sulfate or sulfite introduced to the aqueous solution may be in a di-, or mono-basic form. Thus phosphate, sulfate, and/or sulfite may be added to the aqueous solution in a variety of protonated forms.

The following discussion will be presented, for explanatory purposes alone, with specific reference to an embodiment of the invention in which the aqueous solution is a brine and the iron salt precipitate that is formed is an iron phosphate precipitate. One of ordinary skill in the art will understand that the following discussion may similarly apply to other embodiments of the invention, for example, those in which the iron salt precipitate that is formed is an iron sulfate or an iron sulfite precipitate.

As described above, addition of phosphate anions to the brine combined with an adjustment (e.g. lowering) of the pH of the brine through the addition of one or more acids facilitates the formation of an iron phosphate precipitate. The resultant precipitate may be removed by any means known in the art. For example, the precipitate may be filtered from the solution using any suitable filtration device such as a filter and a plate and frame type filter. Alternatively, a settling process, or a centrifuge may be used to separate the iron phosphate precipitate from the brine. Still further, in those embodiments in which iron phosphate colloidal suspension is generated, a flocculating agent may be added to the solution to flocculate the iron phosphate causing it to come out of suspension.

In one or more embodiments of the invention, residual phosphate anions may remain in the brine solution after formation and separation of the iron phosphate precipitate. For instance, phosphate anions may be added, through the addition of a phosphate salt and/or phosphoric acid, in molar excess to of a molar concentration of iron in the brine. For example, in certain embodiments, phosphate anions may be added to the solution in a molar excess of about 2 to about 4 times the molar concentration of iron in the solution. In other embodiments, the phosphate to iron molar ratio may be about 1 or greater. Any phosphate to iron molar ratio may be effective for removing phosphate from the brine depending on a pH and composition of the brine.

In those embodiments in which a molar excess of phosphate is introduced to the brine, residual phosphate may remain in solution after formation and separation of the iron phosphate precipitate. An alkali or an alkaline earth agent such as an oxide or hydroxide may be added to the brine to adjust (e.g. raise) or readjust the pH of the brine, thereby facilitating formation of an alkali earth phosphate precipitate. Any alkali or an alkaline agent that renders phosphate insoluble through pH adjustment may be used. For example, calcium oxide or calcium hydroxide may be used. If solution contains adequate amount of calcium, for example, if the brine is a calcium-based brine, an alkali agent can achieve the same objective.

In an embodiment of the invention, lime may be added to the brine after the initial pH adjustment. Addition of the lime may be done in a controlled manner to produce a controlled readjustment of the pH of the solution. The change in pH, and the presence of calcium ions, induces the formation of a calcium phosphate precipitate. In one embodiment of the invention, the formation of the residual anion precipitate may be facilitated by the readjustment of the pH of the solution to about 2.5 or higher through the addition of a sufficient amount of an alkali earth oxide or hydroxide. In another embodiment, when the residual solution has adequate amount of calcium, an alkali agent can be used to precipitate calcium phosphate. The extent of pH readjustment needed to maximize precipitation of the residual phosphate is dependent on brine composition. An amount of alkali or alkaline earth agent required to form a precipitate with the residual phosphate may be reduced by minimizing an amount of phosphate anions initially introduced to the solution. Any amount of phosphate ions added in molar excess of an amount of iron in solution may result in more residual phosphate anions, and thus may require a greater amount of alkali or alkaline earth agent be supplied to the solution to render the residual phosphate ions insoluble.

The precipitate that results from the addition of an alkali or alkaline earth agent to the solution, e.g. calcium phosphate in the embodiment in which the anions are phosphate anions and the alkali or alkaline earth agent is sodium hydroxide or lime, may be separated from the brine using any technique known in the art. For example, the precipitate may be separated from the brine solution using any technique known in the art including those discussed earlier. In one or more embodiments, the pH readjustment by addition of sodium hydroxide or lime may be conducted within 1-60 minutes following the pH adjustment by addition of the one or more acids. In yet other embodiments, the pH readjustment and removal of the iron phosphate precipitate and the calcium phosphate precipitate may be carried out within 1-60 minutes after the pH adjustment by addition of the one or more acids is completed. Even without the removal of residual phosphate ions, iron can be removed rapidly in 1-60 minutes.

In accordance with one or more embodiments of the invention, any of the previously disclosed methods of the invention may be used to achieve rapid on-site reclamation of used brine solutions that comprises iron. Due to the high costs associated with brine solutions, it is desirable to reuse (or “reclaim”) used brines. Reclamation of used brine involves eliminating any contaminants from the brine that may have been introduced during oil and gas operations or transportation.

Iron may be present in the dissolved, colloidal or suspended form in the brine solution. It exists either in the reduced form as ferrous iron or in the oxidized form as ferric iron. Conventional methods for iron removal involve adjustments of pH by the addition of lime to the brine solutions to precipitate the ferrous and ferric ions as ferrous hydroxide and ferric hydroxide respectively. In some brine solutions, especially calcium- and zinc-based brine solutions, an acid like hydrochloric acid may added to first lower the alkalinity of the solution, followed by the addition of lime to the solution to convert the iron to iron hydroxide. While these methods may he carried out at the rig site under ideal conditions, they are ideally carried out at the plant under the supervision of an experienced fluid engineer.

Conventional methods of iron removal may further present several disadvantages including an inordinate amount of reaction time, the use of strong oxidizing agents, chemical chelating agents, other chemicals, and/or the addition of excessive amounts of activated carbon. Any such agents or chemicals, not added by the manufacturer as part of the original brine solution, may be considered a contaminant and, therefore, must he removed to return the brine solution back to its original condition. In addition, some conventional methods may involve the use of chemicals that may he damaging to the environment.

One or more embodiments of the invention provide for the rapid removal of iron from a brine solution in an environmentally friendly manner without the use of chemical chelating agents, and other chemicals, and advantageously, may be performed at a rig site. In one or more embodiments, used brine is deposited in a mixing pit, tote, tank, or any other receptacle suitable for storing and mixing fluids. The used brine may have a density ranging from about 8.3 ppg to about 19.5 ppg and a pH in the range of about 10 to about 0. Some embodiments of the invention may result in more efficient iron removal from low-density brines, i.e., brines having a density less than about 16 ppg. In certain embodiments, iron present in high-density brines such as zinc-based brines may not precipitate as effectively upon addition of phosphate ions as compared to low density brines.

In an embodiment of the invention, the used brine may he treated in a continuous mode. Reclamation of the used brine via methods of the invention may return the brine to a “new” brine condition or to substantially the same condition that the brine was in before use. A residual iron content of the reclaimed brine may he from about 100 ppm to about less than 1 ppm. The one or more embodiments of the invention may be used to achieve rapid removal of iron from brine or other aqueous solutions. Steps of methods of the invention may be conducted in substantially real-time. Further, at least a portion of a method for removing iron from an aqueous solution in accordance with one or more embodiments of the invention may be performed at a rig site rather than at a remote location thereby reducing the cost associated with transport of the used or unused brine.

The one or more embodiments of the invention for the removal of iron from a brine solution may be carried out at any temperature. In one embodiment, the removal of iron may be carried out at ambient temperature and/or ambient pressure. Moreover, embodiments of the invention are capable of being carried out in an environmentally friendly manner. In accordance with methods of the invention, additional fluid contaminants are not introduced into the brine and the composition of the brine after iron removal is the same or substantially the same as the composition of the brine before iron removal. Reclamation of the brine obviates the need to dispose of the brine thereby reducing cost and waste to the environment.

In yet another embodiment, a method for removing iron from a brine solution comprises: introducing a source of anions to the brine solution to facilitate formation of an iron salt precipitate, wherein the iron salt precipitate is facilitated by adjusting the pH of the brine solution to lower than about 6.5; and separating the iron salt precipitate from the brine solution. Advantageously, the source of anions is a non chelate.

### EXPERIMENTAL EXAMPLE

An aliquot of 85% phosphoric acid (equivalent to 3.4 gal acid/100 bbl brine) was first added to a 15.5 ppg Zn/CaBr₂/Cl₂ fluid comprising 115 ppm Fe. The neat pH of the fluid was lowered from 4.7 to 4.6 as a result of the addition of the phosphoric acid. Hydrochloric acid (40 gal/100 bbl as 36-37%) was then added to the solution resulting in a lowering of the pH of the solution to about 2.5. It was determined that the soluble iron level of the solution was lowered within 15 minutes to 5 ppm or lower. The minimum detection limit of the measuring kit, used in this experiment, to determine the soluble iron level was 5 ppm. Therefore, it may be possible that the soluble iron level may have been lower than 5 ppm.

An aliquot of 25 wt % lime slurry (3.5 lb/bbl as 100% lime) was then added to the fluid to remove any residual phosphate anions present in solution. The addition of the lime slurry resulted in an increase of the pH of the fluid to about 4.8 leading to the formation of a lime phosphate precipitate. The precipitate was filtered from the fluid. It was determined that <1 ppm Fe and 12 ppm P were present in the solution and that the solution had a density of 15.4 ppg. As the above experimental data shows, embodiments of the invention are capable of reducing iron and phosphate levels in solution to very low levels.

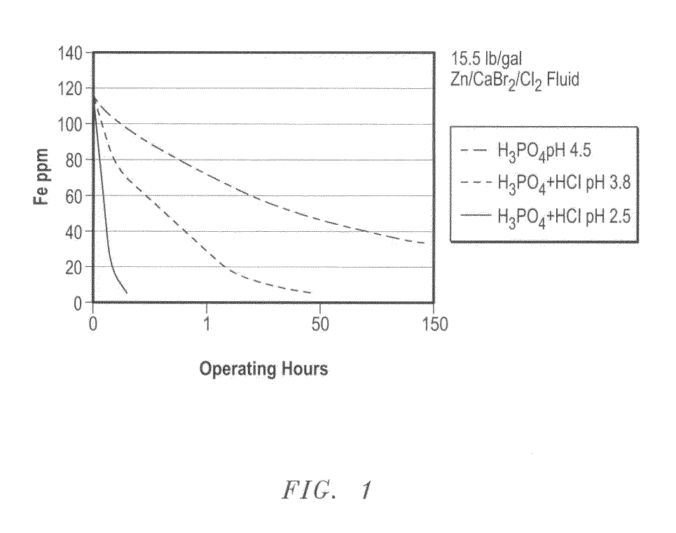

FIG. 1 is a plot of Fe concentration (in ppm) as a function of a number of hours of operation of an iron removal process performed at different solution pH levels according to embodiments of the invention. As shown, an iron precipitation rate at a pH of 4.5 is slow. However, in accordance with an embodiment of the invention, the iron concentration in solution is rapidly reduced within about 15 minutes, to a negligible amount, at a solution pH of 2.5. As depicted, iron concentration at a solution pH of 4.5 is reduced from about 115 ppm to about 32 ppm over a period of more than 150 hours. In stark contrast, iron concentration in solution declines from about 115 ppm to less than or equal to 5 ppm within about 50 hours of operation at a pH of 3.8 thereby illustrating the rapidity and efficiency with which methods according to embodiments of the invention remove iron from aqueous solutions.

While the foregoing describes various embodiments of the invention, other and further embodiments of the invention may be devised without departing from the basic scope thereof. The scope of the invention is determined by the claims that follow. The above-described embodiments of the invention are presented by way of example only and the invention is not limited thereto.

What is claimed is:

1. A method for removal of iron from an aqueous solution, the method comprising:
introducing a source of anions to the aqueous solution to facilitate formation of an iron salt precipitate, the iron salt precipitate facilitated by adjusting the pH of the aqueous solution to lower than about 6.5;
separating the iron salt precipitate from the aqueous solution, the aqueous solution comprising residual anions; and
removing the residual anions by facilitating the formation of an alkali earth anion precipitate by adjusting the pH of the aqueous solution to about 2.5 or greater by adding an alkali or alkali earth oxide or hydroxide to the aqueous solution.

2. The method of claim 1, wherein the aqueous solution is a brine used for an oil and gas operation.

3. The method of claim 2, wherein the brine is at least one of: a work-over brine, a completion brine, frac water, and a flowback fluid.

4. The method of claim 1, the pH adjusted by introduction of one or more acids to the aqueous solution, the one or more acids comprising at least one of:
phosphoric acid, sulfuric acid, hydrochloric acid, hydrobromic acid, formic acid and acetic acid.

5. The method of claim 1, the facilitating the formation of the iron salt precipitate comprising adjusting the pH of the brine to lower than about 6.5 by adding an acid, the acid selected from the group consisting of hydrochloric acid, phosphoric acid, sulfuric acid, or sulfurous acid.

6. The method of claim 1, the source of anions selected from the group consisting of phosphoric acid, sulfuric acid, sulfurous acid, a sulfate salt or a phosphate salt.

7. The method of claim 1, further comprising removing the iron salt precipitate and the alkali earth anion precipitate, the iron salt precipitate removed prior to the formation of the alkali earth ion precipitate.

8. The method of claim 1, further comprising removing the iron salt precipitate and the alkali earth anion precipitate, the iron salt precipitate removed along with the formation of the alkali earth ion precipitate.

9. A method for rapid removal of iron from an aqueous solution, the method comprising:
facilitating formation of an iron phosphate precipitate by introducing a source of anions to the aqueous solution;
separating the iron phosphate precipitate from the aqueous solution; and
removing residual phosphate ions from the aqueous solution.

10. A method for removal of iron from a brine solution, the method comprising:
introducing a source of anions to the brine solution to facilitate formation of an iron salt precipitate, the iron salt precipitate facilitated by adjusting the pH of the brine solution to lower than about 6.5; and
separating the iron salt precipitate from the brine solution,
wherein the source of anions is a non chelate.

11. A method for rapid removal of iron from a brine, the method comprising:
facilitating formation of an iron phosphate precipitate in the brine;
separating the iron phosphate precipitate from the brine; and
removing residual phosphate ions from the brine,
the brine for use in an oil and gas operation.

12. The method of claim 11, the facilitating the formation of the iron phosphate precipitate comprising:
introducing a source of phosphate anions to the brine; and
adjusting the pH of the brine to lower than about 6.5 by adding one or more acids to the brine, the one or more acids comprising at least one of phosphoric acid, hydrochloric acid, sulfuric acid, hydrobromic acid, formic acid and acetic acid.

13. The method of claim 11, the facilitating the formation of iron phosphate precipitate comprising:
adjusting the pH of the brine to within a range of about 2.5 to about 4.5 by adding hydrochloric acid and phosphoric acid to the brine.

14. The method of claim 11, the facilitating the formation of iron phosphate precipitate comprising:
adjusting the pH of the brine to within a range of about 2.5 to about 4.5 by adding hydrochloric acid and a phosphate salt to the brine.

15. The method of claim 11, the removing the residual phosphate ions comprising:
facilitating formation of a calcium phosphate precipitate by readjusting the pH of the brine, the pH readjustment made by addition of sodium hydroxide or lime to the brine, the pH readjustment made within 1-60 minutes following the completion of the pH adjustment; and
removing the calcium phosphate precipitate from the brine.

16. The method of claim 15, wherein the pH readjustment modifies the pH of the brine to about 2.5 or greater.

17. The method of claim 12, wherein the phosphate ions are added to the brine in molar excess of an amount of iron in the brine.

18. The method of claim 17, wherein the molar excess is from about 2 to about 4 times the amount of iron in the brine.

19. The method of claim 11, further comprising reclamation of the brine by removing the iron from the used brine, the reclamation conducted at an on-site location.

20. The method of claim 19, wherein a residual iron content of the reclaimed brine is within a range of about 100 ppm to about less than 1 ppm.
